(19) United States
(12) Patent Application Publication
(10) Pub. No.: US 2018/0176997 A1
(43) Pub. Date: Jun. 21, 2018

(54) AC DECOUPLING AND FILTERING OF MULTI-CHANNEL QUASI-RESONANT (QR) INVERTERS IN INDUCTION COOKTOPS

(71) Applicant: Haier US Appliance Solutions, Inc., Wilmington, DE (US)

(72) Inventors: Isaac Nam, Louisville, KY (US); Ali Jordan Faraji-Tajrishi, Louisville, KY (US); Meher Prasadu Kollipara, Louisville, KY (US)

(21) Appl. No.: 15/379,552

(22) Filed: Dec. 15, 2016

(51) Int. Cl. H05B 6/06; H05B 6/04

(52) U.S. Cl. CPC H05B 6/062; H05B 6/04

(57) ABSTRACT

Systems and methods of quasi-resonant induction heating are provided. In particular, an induction heating system having quasi-resonant inverters in an induction cooktop for improved controllability of multi-channel quasi-resonant inverters. The inverter can include an induction heating coil configured to inductively heat a load with a magnetic field, and a power supply circuit configured to supply a power signal to the induction heating coil. The inverter can further include one or more switching elements. The inverter can further include a resonant capacitor coupled in parallel with the induction heating coil. The inverter can further include having separate rectifiers in each channel to improve controllability.

### FIELD

The present subject matter relates generally to induction cooktops.

### BACKGROUND

Induction cooking appliances can be more efficient, have greater temperature control precision and provide more uniform cooking than other conventional cooking appliances. In conventional cooktop systems, an electric or gas heat source is used to heat cookware in contact with the heat source. This type of cooking can be inefficient because only the portion of the cookware in contact with the heat source is directly heated. The rest of the cookware is heated through conduction that causes non-uniform cooking throughout the cookware. Heating through conduction can take an extended period of time to reach a desired temperature.

In contrast, induction cooking systems use electromagnetism which turns cookware of the appropriate material into a heat source. A power supply provides a signal having a frequency to the induction coil. When the coil is activated, a magnetic field is produced that induces a current on the bottom surface of the cookware. The induced current on the bottom surface then induces even smaller currents (e.g., Eddy currents) within the cookware thereby providing heat throughout the cookware.

### BRIEF DESCRIPTION

Aspects and advantages of embodiments of the present disclosure will be set forth in part in the following description, or can be learned from the description, or can be learned through practice of the embodiments.

One example aspect of the present disclosure is directed to an induction heating system. The induction heating system includes a power source configured to supply power to the heating system. The induction heating system further includes a plurality of inverter channels. Each inverter channel includes an induction heating coil configured to inductively heat a load with a magnetic field. Each inverter channel further includes a capacitor coupled with the induction heating coil. Each inverter channel further includes one or more switching elements. Each inverter channel includes a one or more rectifiers disposed in each inverter channel.

Another example aspect of the present disclosure is directed to a method of powering a plurality of induction heating coils in a cooktop. The method includes receiving a signal from a power source. The method further includes distributing the signal among a plurality of inverter channels. Each inverter channel includes an induction heating coil configured to inductively heat a load with a magnetic field. Each inverter channel includes a resonant capacitor coupled with the induction heating coil. Each inverter channel further includes one or more switching elements. Each inverter channel has one or more rectifiers. The method further includes rectifying the signal in each inverter channel to generate a rectified signal. The method further includes providing the rectified signal in each inverter channel to the induction heating coil in each inverter channel.

Yet another example aspect of the present disclosure is directed to a cooking appliance having an induction heating quasi-resonant cooktop. The quasi-resonant cooktop includes a power source configured to supply power to the cooking appliance. The cooking appliance further includes a plurality of quasi-resonant inverter channels. Each inverter channel includes an induction heating coil configured to inductively heat a load with a magnetic field. Each inverter channel includes a capacitor coupled with the induction heating coil. Each inverter channel includes one or more switching elements. Each inverter channel further includes a rectifier stage having one or more rectifiers disposed in the inverter channel.

Variations and modifications can be made to these example embodiments. These and other features, aspects and advantages of various embodiments will become better understood with reference to the following description and appended claims. The accompanying drawings, which are incorporated in and constitute a part of this specification, illustrate embodiments of the present disclosure and together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example induction cooktop appliance according to example embodiments of the present disclosure.

FIG. 2 depicts a circuit diagram of an example quasi-resonant inverter for use in an induction heating system according to example embodiments of the present disclosure.

FIG. 3 depicts a circuit diagram of parallel quasi-resonant inverters for use in an induction heating system according to example embodiments of the present disclosure.

FIG. 4 depicts a circuit diagram of a dual-channel quasi-resonant inverter with choke inductors and channel-decoupling inductors according to example embodiments of the present disclosure.

FIG. 5 depicts a circuit diagram of a dual-channel quasi-resonant inverter with rectified-side choke inductors according to example embodiments of the present disclosure.

FIG. 6 depicts a flow diagram of an example method according to example embodiments of the present disclosure.

### DETAILED DESCRIPTION

Reference now will be made in detail to embodiments of the present disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Example aspects of the present disclosure are directed to multi-channel induction cooktops. A multi-channel induction cooktop can include a plurality of inverter channels configured to power induction heating coils. The control can be complicated because the inverter channels are directly coupled for multi-channel operation. The operation of each channel can be dependent on the operation of other channels and interference caused by the other channels. According to example embodiments, separate rectifiers can be employed in each channel to mitigate the interference caused during multi-channel operation.

High rectifier current peaks can occur when using separate rectifiers. Sub-harmonic ripples in inverters can become undesirably high as well. Sub-harmonic noises can be significant when multiple quasi-resonant (QR) inverters are switching on and off with different frequencies, duty cycles and phases. Increased ripples can be seen in resonant coil currents and they can increase possible audible noises. According to example embodiments, choke inductors and channel-decoupling inductors can be used to address sub-harmonic noises and high current peaks. When an X capacitor (across the line capacitor) is employed for a low pass filter, the diode bridge rectifiers can be in the voltage-driven configuration. During diode bridge conduction cycles, the X capacitor can get in parallel with the bus capacitors. This parallel configuration can cause current spikes between the X capacitor and bus capacitors. Choke inductors can be employed to reduce such current peaks. In example embodiments, channel-decoupling inductors can be used to reduce frequency ripples in rectifier currents so that softer transitions can occur without increased higher frequency ripples. As a result, the present disclosure can reduce power losses in rectifiers. Example embodiments of the present disclosure can reduce sub-harmonic ripples including possible audible noises in cooktop coils caused by the difference between switching frequencies of quasi-resonant inverters. According to example aspects of the present disclosure, implementing channel-decoupling inductors can provide improvements in terms of audible noises, control of multi-channel quasi-resonant inverters, and performance in electromagnetic interference (EMI) reduction.

In this way, example aspects of the present disclosure can provide a number of technical effects and benefits. For example, by employing a separate rectifier for each channel, improved controllability of each channel can be possible. Choke inductors can be employed to reduce high current peaks. Channel-decoupling inductors can be used to reduce large rectifier current spikes so that softer transition of current waveforms can occur. As a result, the present disclosure can reduce power losses in rectifiers by high frequency current spikes. Example embodiments of the present disclosure can reduce sub-harmonic ripples including possible audible noises. According to example aspects of the present disclosure, implementing channel-decoupling inductors can provide improvements in terms of audible noises, cost, power density and power transfer efficiency without losing performance in electromagnetic interference (EMI) reduction.

Referring now to the figures, example aspects of the present disclosure will be discussed in greater detail.

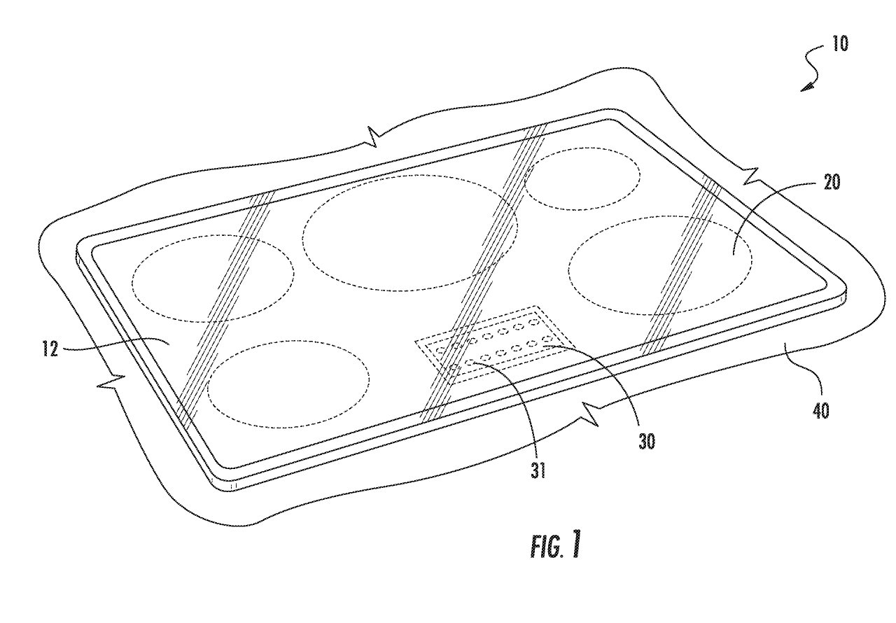

FIG. 1 depicts an induction cooktop 10 according to example embodiments of the present disclosure. Cooktop 10 can be installed in chassis 40 and in various configurations such as cabinetry in a kitchen, coupled with one or more ovens or as a stand-alone appliance. Chassis 40 can be grounded. Cooktop 10 includes a horizontal surface 12 that can be glass or other suitable material. Induction coil 20 can be provided below horizontal surface 12. It can be understood that cooktop 10 can include a single induction coil or a plurality of induction coils.

Cooktop 10 is provided by way of example only. The present disclosure can be used with other configurations. For example, a cooktop having one or more induction coils in combination with one or more electric or gas burner assemblies. In addition, the present disclosure can be used with a cooktop having a different number and/or positions of burners. The present disclosure can also be used with induction cooktops installed on ranges.

A user interface 30 can have various configurations and controls can be mounted in other configurations and locations other than as shown in the embodiment. In the illustrated embodiment, the user interface 30 can be located within a portion of the horizontal surface 30, as shown. Alternatively, the user interface can be positioned on vertical surface near a front side of the cooktop 10 or other suitable location. The user interface 30 can include, for instance, a capacitive touch screen input device component 31. The input component 31 can allow for the selective activation, adjustment or control of any or all induction coils 20 as well as any timer features or other user adjustable inputs. One or more of a variety of electrical, mechanical or electro-mechanical input device including rotary dials, push buttons, and touch pads can also be used singularly or in combination with the capacitive touch screen input device component 31. The user interface 30 can include a display component, such as a digital or analog display device designed to provide operation feedback to a user.

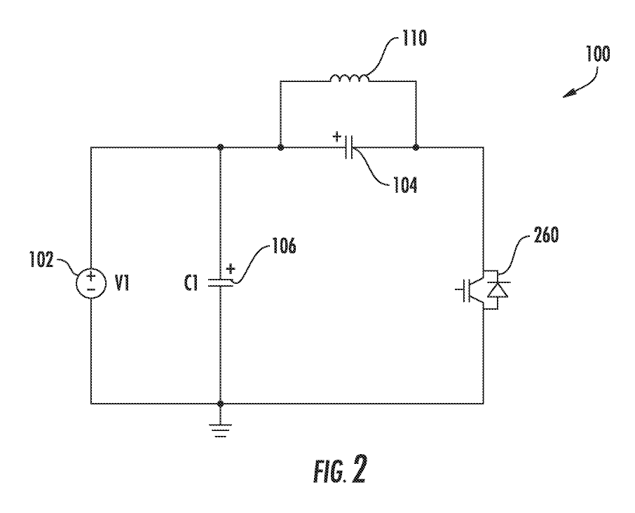

FIG. 2 depicts a circuit diagram of quasi-resonant inverter 100 for use in an induction heating system according to example embodiments of the present disclosure. Inverter 100 includes induction coil 110 and resonant capacitor 104. In particular, induction heating coil 110 and resonant capacitor 104 can correspond to a resonant tank circuit. Induction coil 110 can be configured to receive one or more power signals from alternating current (AC) source 102. Alternatively, any other power source can be used. For instance a one phase 120V power supply, a three phase power supply, a generator, a battery, and/or any direct current (DC) power source.

Inverter 100 further includes switching element 260. Switching element 260 can be insulated-gate bipolar transistors (IGBTs), metal-oxide-semiconductor field-effect transistors (MOSFETs), or any other suitable switching element. It will be appreciated that inverter 100 can include more switching elements, such as two switching elements, three switching elements, etc. In some implementations, switching element 260 can have an anti-parallel diode. Switching element 260 can control operation of induction heating coil 110. In particular, switching element 260 can receive control commands from one or more control devices, such as one or more gate drivers or other control devices. For instance, control commands can be determined based at least in part on one or more switching control signals provided from a controller. In some implementations, switching element 260 can receive control signals from an independent control device. The control signals can cause switching element 260 to turn on or off during one or more time periods for different durations at different switching frequencies so that power in induction heating coil 110 is varied.

In some implementations, switching element 260 can be turned on and off such that inverter 100 is operated at a desired operating frequency to obtain soft-switching mechanisms including zero-voltage switching (ZVS) and zero-voltage/zero-zero-voltage-derivative switching (ZVS/ZVDS). Inverter 100 can be controlled to operate in a plurality of charging phases wherein induction heating coil 110 stores energy, and in a plurality of resonant phases wherein energy stored during the previous charging phase oscillates between induction heating coil 110 and resonant capacitor 104 to generate an alternating current signal. The charging phases can approximately correspond to the time periods wherein switching element 260 is turned on. The resonant phases can approximately correspond to the periods of time wherein switching element 260 is turned off. In this manner, inverter 100 can be controlled such that current flows through switching element 260 during a first subset of charging phases, and not during a second subset of charging phases.

For instance, during a first charging phase of inverter 100, switching element 260 can be turned on (e.g., by applying sufficient gate voltage to switching element 260) during a first time period to allow induction heating coil 110 to charge to a sufficient level. Switching element 260 can then be turned off to allow the energy stored by induction heating coil 110 during the first charging phase to oscillate (e.g., during a first resonant phase of inverter 100) between induction heating coil 110 and resonant capacitor 104, such that an alternating current signal is produced at or near the resonant frequency.

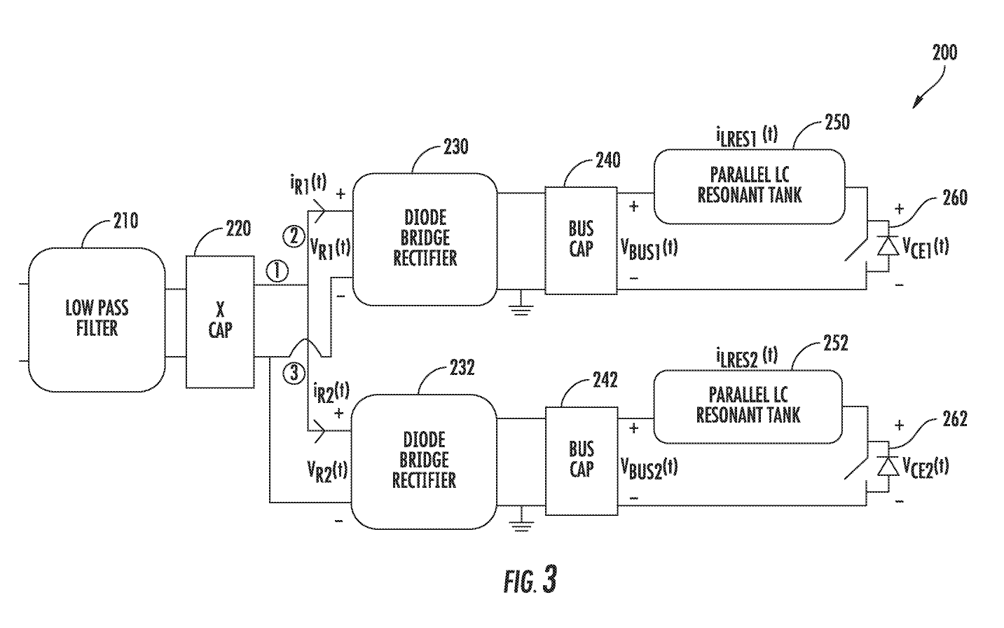

FIG. 3 depicts a block diagram of induction heating system 200 for use with an induction cooktop according to example embodiments of the present disclosure. System 200 can include low-pass filter 210, across the line X-capacitor 220, diode bridge rectifiers 230, 232, bus capacitors 240, 242, resonant tanks 250, 252 and switching elements 260, 262.

When a power supply signal is provided, low pass filter 210 can be used to modify, reshape, or reject unwanted frequencies. Low pass filter 210 can be used to allow low frequency signals to pass unaltered while attenuating all other high signals that are not wanted. Low pass filter 210 can be coupled to across the line capacitor 220 before the signal is split across each channel. After the signal is split across each channel, it can be provided to rectifiers 230, 232.

Rectifiers 230, 232 can convert the AC power signal into a DC signal. The rectification that is illustrated is a diode bridge rectifier having a pair of AC input terminals and DC output terminals. The rectified terminals of the diode bridge rectifiers 230, 232 are connected to rectified supply 102. This rectified signal 102 can be approximately DC voltage at a small load condition of inverter 100 and can be approximately a rectified AC voltage at a large load condition of inverter 100. A separate rectifier can be used for each channel. Having separate rectifiers for each channel can decrease channel interference that can exist when multiple channels are directly coupled together. Using separate rectifiers for each channel can allow the voltages across bus capacitors 240, 242 to be compared with each channel's corresponding switch voltages across switching elements 260, 262 without significant channel-to-channel interference so that each channel's operation can be determined independently of another channel. As a result, Operations such as zero-voltage switching can be achieved for multiple channels containing separate rectifiers.

Induction system 200 can include resonant tanks 250, 252. Each resonant tank includes an induction coil coupled in parallel and/or in series with a capacitor to form a resonant tank. Resonant tanks 250, 252 can be used to convert the rectifier low-frequency signal provided from the rectifiers into a high-frequency, high peak signal in the induction coil to create magnetic field used for induction heating for cooking. Resonant tanks 250, 252 can be employed in a variety of inverter configurations. For instance, a half-bridge inverter, a full-bridge inverter, or a polyphaser inverter can be provided. Each resonant tank can act as an oscillator to generate an alternating high peak current signal. Induction system 200 can include switching elements 260, 262 as described in FIG. 2. Switching elements 260, 262 can be coupled in series with resonant tanks 250, 252. In some implementations, switching elements 260, 262 can be controlled in an alternating manner to achieve a desired power output and/or operating frequency of the inverter.

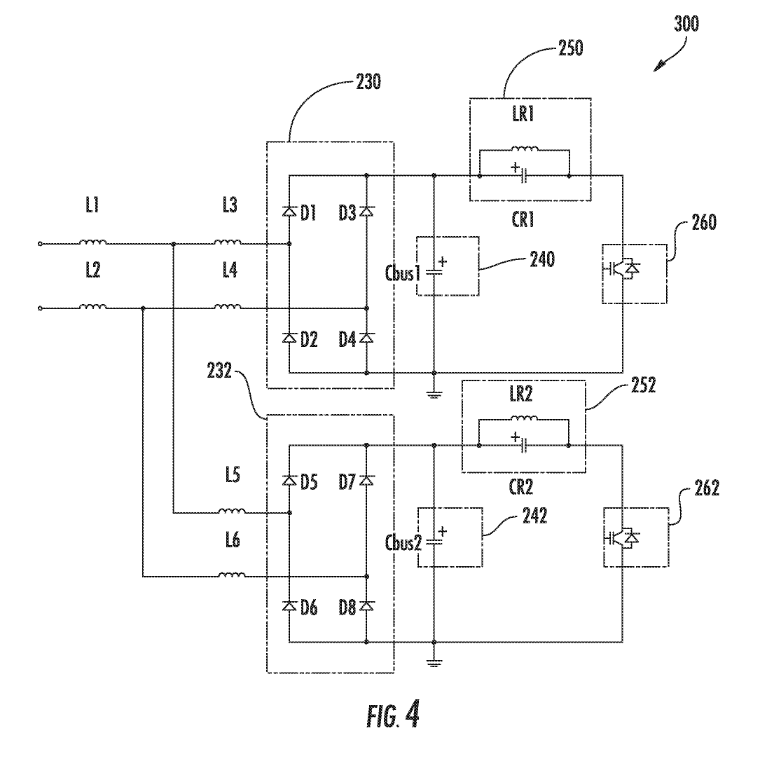

FIG. 4 depicts a circuit diagram of a dual-channel inverter as disclosed in FIG. 3. Dual-channel inverter 300 includes choke inductors L1, L2, channel-decoupling inductors L3, L4, L5, L6, diode bridge rectifiers 230, 232, bus capacitors 240, 242, resonant tanks 250, 252, induction coils LR1, LR2, resonance capacitors CR1, CR2, and switching elements 260, 262.

Rectifiers 230, 232 can be used to convert AC input signal into a rectified signal 102 for each channel as described in FIG. 3. Each channel can have a separate rectifier as described above. Although rectifiers 230, 232 are full-wave bridge rectifiers, it will be appreciated that any suitable rectifier can be included without deviating from the scope of the present disclosure. Resonant tanks 250, 252 can be coupled between bus capacitors 240, 242 and switching elements 260, 262. Resonant tanks 250, 252 include induction coils LR1, LR2 and resonance capacitors CR1, CR2. Resonant tanks 250, 252 can be used to convert the rectifier low frequency signal received from rectifiers 230, 232 into high-frequency, high peak signals in the induction coil to create magnetic field used for induction heating for cooking. Induction coils LR1, LR2 can include any configuration or material capable of creating magnetic field that can produce eddy currents within a cookware. For example, materials such as but not limited to ferrite or any other ferromagnetic materials can be included in induction coils LR1, LR2. For instance, induction coil LR1, LR2 can include windings in a horizontal direction, a vertical direction, or a combination of horizontal and vertical directions.

Choke inductors L1, L2 can be employed between filter stage 210 and the rectifiers 230, 232. Choke inductors L1, L2 can be employed instead of X-capacitor 220 or after X-capacitor 220 and before the rectifiers 230, 232 to reduce rectifier input currents which can have high instantaneous current peaks due to X-capacitor 220 being in parallel with bus capacitors 240, 242 during the conduction cycle of the diode rectifiers. Employing choke inductors L1, L2 in such configuration can transform rectifiers 230, 232 into current-driven rectifiers that can block unwanted high frequency current peaks. Employing choke inductors L1, L2 in such configuration may not be useful for mitigating channel interference, meaning that such configuration may not help with removing heterodyne frequency ripples on bus voltages across bus capacitors 240, 242. Instead, channel-decoupling inductors L3, L4, L5, L6 can be employed to obtain current-driven rectifiers while mitigating channel interference by reducing heterodyne frequency ripples on bus voltages. Therefore, channel-decoupling inductors L3, L4, L5, L6 can not only help at reducing unwanted high frequency current spikes but can also help reduce heterodyne voltage ripples and audible noises. It will be appreciated that various other suitable distribution schemes can be used. For instance, only a single channel-decoupling inductor can be employed for each channel (e.g., only L3 and L5 are included without L4 and L6). In other embodiments, channel-decoupling inductors L3, L4, L5, L6 can be employed without choke inductors L1, L2. All choke inductors can be differential-mode (DM) choke inductors or common-mode (CM) choke inductors having some leakage inductances. Employing choke inductors L1 through L6 in various schemes can help provide noise filtering. For example employing L1 and L2 as balanced DM chokes or as a CM choke can provide both DM noise filtering and CM noise filtering. In other embodiments, employing channel-decoupling inductors L3 through L6 in balanced DM choke configuration or CM choke configuration can provide both DM noise filtering and CM noise filtering.

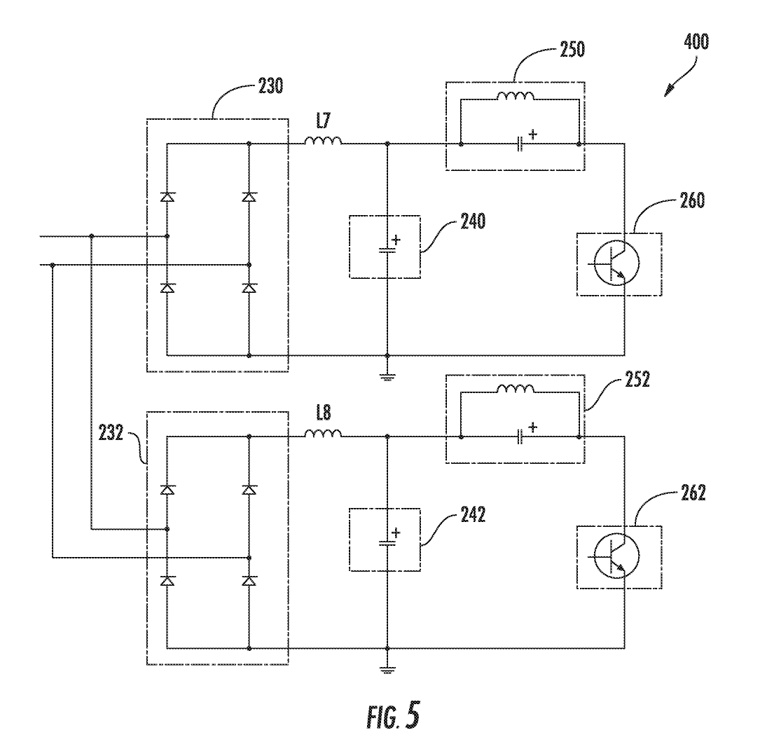

FIG. 5 depicts a circuit diagram of a dual-channel inverter as disclosed in FIG. 4 but without choke inductors L1 through L6 and with the addition of rectified-side choke inductors L7, L8. Rectified-side choke inductors L7 can be coupled between rectifier 230 and bus capacitor 240. Rectified-side choke inductor L8 can be employed between rectifier 232 and bus capacitor 242. Employing rectified-side choke inductors L7, L8 in such configuration can help mitigate channel interference and can reduce heterodyne frequency ripples, audible noises, and high current spikes. Each channel can include its own rectified-side choke inductor coupled to the respective rectifier in the channel. In such configuration, X-capacitor 220 still makes rectifiers to be in voltage-driven configuration, however rectified-side choke inductors L7, L8 provide AC-decoupling between X-capacitor and bus capacitors so that high current spikes can be avoided. Rectified side choke inductors L7, L8 may not provide common-mode CM noise filtering.

Switching elements 260, 262 can be coupled in series with resonant tanks 250, 252 and can be IGBTs. In an alternate embodiment, any suitable switching devices can be used such as MOSFETs. Operation of switching elements 260, 262 can be controlled in accordance with various suitable control schemes or techniques. For example, in some implementations, switching elements 260, 262 can be controlled in accordance with a ZVS technique, ZVS/ZVDS technique or other switching technique such as a low voltage hard-switching technique. In this manner, switched on duration and switching frequency can be controlled so that after switches are turned off, sufficient resonant swing of voltages across 260, 262 can occur. This sufficient resonant swing can allow switch voltages to softly reach zero within switched-off duration. As a result, switching element 260,262 can be turned on at or near this zero instances—achieving zero-voltage turn on transition. The control signals can be pulses having a sufficient voltage to cause the switching elements to turn on. The length of the pulses can be determined to facilitate operations at a desired frequency with desired switched on-duration. In particular, the length of the pulses can be determined based at least in part on the inductance of induction coil LR1 and the capacitance of resonant capacitor CR1, the resonance frequency of inverter 100, a desired peak current level associated with induction heating coil 202, one or more user inputs indicative of a desired temperature or output level, a resistance associated with the load (e.g., resistance of a vessel or other cooking utensil) and/or other suitable signals. For instance, one or more user input signals can be provided through user interaction with user interface 30 and/or input component 31 depicted in FIG. 1.

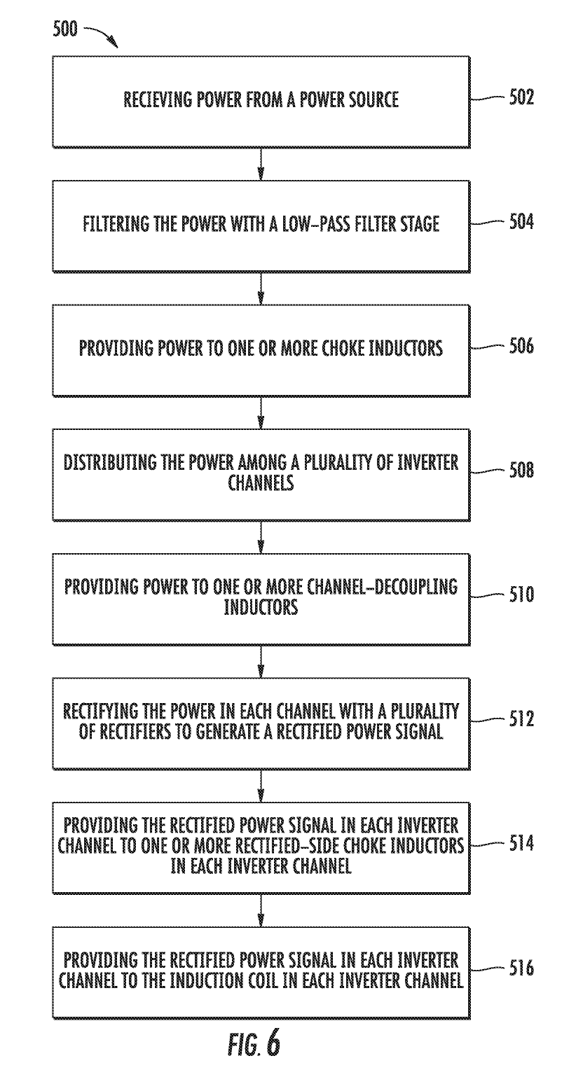

FIG. 6 depicts a flow diagram of an example method 500 of controlling an induction heating system according to example embodiments of the present disclosure. Method 500 will be discussed with reference to dual-channel inverters 300 and 400 of FIGS. 4 and 5. However, method 500 can be implemented with any suitable induction cooktop system. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the method can be omitted, rearranged, combined and/or adapted in various ways. Those of ordinary skill in the art, using the disclosures provided herein will understand that the methods discussed herein can be adapted, rearranged, expanded, omitted, or modified in various ways without deviating from the scope of the present disclosure. Method 500 can be implemented by one or more control devices.

By way of example, any/all of the “control devices” discussed in this disclosure can include a memory and one or more processing devices such as controllers, CPUs or the like, such as general or special purpose microprocessors operable to execute programming instructions or micro-control code associated with operation of an induction cooktop appliance 10. The memory can represent random access memory such as DRAM, or read only memory such as ROM or FLASH. In one embodiment, the processor executes programming instructions stored in memory. The memory can be a separate component from the processor or can be included onboard within the processor. Alternatively, the controller might also be constructed without using a microprocessor, using a combination of discrete analog and/or digital logic circuitry (such as switches, amplifiers, integrators, comparators, flip-flops, AND gates, and the like) to perform control functionality instead of relying upon software.

At (502), method 500 can include receiving power from a power source. For instance the power can be from an AC power source. Alternatively, any other power source can be used. For instance a one phase 120V power supply, a three phase power supply, a generator, a battery, and/or any direct current (DC) power source.

At (504), the method can include filtering the power with a low-pass filter stage to remove unwanted noise. For instance, low pass filter 210 can be used to allow low signals to pass while attenuating all other signals that are not wanted as shown in FIG. 3.

At (506), the method can optionally include providing power to one or more choke inductors to reduce unwanted noise. For instance, choke inductors L1,L2 can be employed to reduce rectifier input currents which can have high instantaneous current peaks. Choke inductors L1,L2 can be used to turn rectifiers 230, 232 into current-driven circuits with reduced current peaks.

At (508), the method can include distributing the power among a plurality of inverter channels. After the signal is provided to choke inductors L1, L2, the signal can be split across multiple channels as shown in FIG. 3.

At (510), the method can include providing the power to one or more channel-decoupling inductors. Channel-decoupling inductors L3, L4, L5, L6 can be coupled to rectifiers 230, 232 as shown in FIG. 4. Channel-decoupling inductors can be used to reduce harmonic content as well as audible noises. Various other suitable distribution schemes can be used. For instance, only a single channel-decoupling inductor can be employed. In other embodiments, each channel can include a plurality of channel-decoupling inductors as shown in FIG. 4. Employing channel-decoupling inductors L3 through L6 can lead to improved CM noise filtering, reduction of high frequency current spikes, reduction of heterodyne frequency ripples on bus voltages (channel interferences), and audible noises.

At (512), the method can include rectifying the power in each inverter channel with a plurality of rectifiers to generate a rectified power signal. Rectifiers 230, 232 can be used to convert the signal from an AC power signal to a DC signal. A separate rectifiers can be used for each channel. The rectifier can be a full-wave rectifiers as shown in FIG. 4. In other embodiments, any suitable rectifier can be included.

At (514), the method can optionally include providing power to one or more rectified-side choke inductors L7,L8 coupled to a respective rectifier in each channel. For example, rectified side choke inductors can be coupled between rectifiers 230,232 and bus capacitors 240,242. Employing rectified-side choke inductors L7,L8 in such configuration can help mitigate channel interference and can reduce heterodyne frequency ripples, audible noises and high current spikes. Each channel can include its own rectified-side choke inductor coupled to the respective channel's rectifier.

At (516), the method can include providing rectified power signal in each inverter channel to the induction coil in each inverter channel. Induction coils LR1, LR2 can include conductive materials separated by dielectric materials such as copper coils whose each turn to turn gap is separated by dielectric materials. In addition, induction coil LR1, LR2 can include windings (e.g. solid copper windings, Litz wire, etc.) in a horizontal direction, a vertical direction, or a combination of horizontal and vertical directions. It may be understood that cooktop 10 may include a single induction coil or a plurality of induction coils. The induction coil can be configured to induce current in a load when located on cooktop 10. Quasi-resonant inverter 100 can include a resonant circuit having a set or more sets of an inductor and a capacitor.

Although specific features of various embodiments can be shown in some drawings and not in others, this is for convenience only. In accordance with the principles of the present disclosure, any feature of a drawing can be referenced and/or claimed in combination with any feature of any other drawing.

This written description uses examples for the disclosure, including the best mode, and also to enable any person skilled in the art to practice the disclosure, including making and using any devices or systems and performing any incorporated methods. The patentable scope of the disclosure is defined by the claims, and can include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An induction heating system, the induction heating system comprising:
a power source configured to supply power to the heating system;
a plurality of inverter channels, each inverter channel comprising an induction heating coil configured to inductively heat a load with a magnetic field, a capacitor coupled with the induction heating coil, one or more switching elements; and
wherein each inverter channel comprises one or more rectifiers disposed in each inverter channel.

2. The induction heating system of claim 1, wherein each inverter channel is configured as a resonant tank.

3. The induction heating system of claim 1, wherein each inverter channel is configured as a quasi-resonant inverter.

4. The induction heating system of claim 1, wherein the induction heating system comprises one or more choke inductors.

5. The induction heating system of claim 1, wherein each inverter channel comprises one or more channel-decoupling inductors.

6. The induction heating system of claim 1, wherein the induction heating system comprises one or more choke inductors and one or more channel-decoupling inductors.

7. The induction heating system of claim 1, wherein the induction heating system comprises one or more rectified-side choke inductors coupled to a respective rectifier in the channel.

8. The induction heating system of claim 1, wherein the switching element comprises a semiconductor switch configured to permit a current flow in a first direction, and a diode coupled anti-parallel with the semiconductor switch to block current flow in the first direction and allow current flow in a second direction.

9. A method of powering a plurality of induction heating coils in a cooktop, the method comprising:
receiving a signal from a power source;
distributing the signal among a plurality of inverter channels, wherein each inverter channel comprises an induction heating coil configured to inductively heat a load with a magnetic field, a resonant capacitor coupled with the induction heating coil, one or more switching elements, wherein each inverter channel has one or more rectifiers;
rectifying the signal in each inverter channel to generate a rectified signal;
providing the rectified signal in each inverter channel to the induction heating coil in each inverter channel.

10. The method of claim 9, wherein the switching element comprises a semiconductor switch configured to permit a current flow in a first direction, and a diode coupled in series with the semiconductor switch to block current flow in the first direction and allow current flow in a second direction.

11. The method of claim 9, wherein prior to distributing the signal among the plurality of inverter channels, the method comprises filtering the signal with a low-pass filter stage.

12. The method of claim 9, wherein prior to rectifying the signal in each inverter channel, the method comprises providing the signal to one or more channel-decoupling inductors.

13. The method of claim 9, wherein prior to distributing the signal among the plurality of inverter channels, the method comprises providing the signal to one or more choke inductors.

14. The method of claim 9, wherein prior to rectifying the signal in each inverter channel, the method comprises providing the signal to one or more choke inductors and one or more channel-decoupling inductors.

15. The method of claim 9, wherein subsequent to rectifying the signal in each inverter channel, the method comprises providing the rectified signal in each inverter channel to one or more rectified-side choke inductors.

16. A cooking appliance having an induction heating quasi-resonant cooktop, the quasi-resonant cooktop comprising:
a power source configured to supply power to the cooking appliance;
a plurality of quasi-resonant inverter channels, each inverter channel comprising an induction heating coil configured to inductively heat a load with a magnetic field, a capacitor coupled with the induction heating coil, one or more switching elements; and
wherein each inverter channel comprises one or more rectifiers disposed in each inverter channel.

17. The cooking appliance of claim 16, wherein the cooking appliance comprises one or more choke inductors.

18. The cooking appliance of claim 16, wherein each inverter channel comprises one or more channel-decoupling inductors.

19. The cooking appliance of claim 16, wherein the cooking appliance comprises one or more choke inductors and one or more channel-decoupling inductors.

20. The cooking appliance of claim 16, wherein each inverter channel comprises one or more rectified-side choke inductors coupled to the respective rectifier in each inverter channel.
